(19) United States
(12) Patent Application Publication
(10) Pub. No.: US 2005/0020316 A1
(43) Pub. Date: Jan. 27, 2005

(54) Event list menu for accessing menu items in a hierarchical menu

(76) Inventor: Hassan Mahini, Carrboro, NC (US)

Correspondence Address: COATS & BENNETT, PLLC, P O BOX 5, RALEIGH, NC, 27602, US

(21) Appl. No.: 10/627,896

(22) Filed: Jul. 25, 2003

(51) Int. Cl. H04B 1/38; H04M 1/00

(52) U.S. Cl. 455/566; 455/412.1

(57) ABSTRACT

An events list menu provides quick and easy access to menus associated with desired functions or features of a mobile communication device. The mobile communication device dynamically updates the event list menu responsive to designated events and displays the event list menu responsive to user input. In one embodiment of the invention, the user may display the event list by pressing a shortcut key or a combination of keys. Each event in the event list is associated with a menu item in a hierarchical menu. The associated menu item is invoked when the user selects an event from the event list.

### FIELD OF THE INVENTION

The present invention relates generally to wireless communication devices and, more particularly, to user interfaces for wireless communication devices.

### BACKGROUND OF THE INVENTION

Wireless communication devices, such as cellular telephones, have been used in the past primarily for voice communications. The advent of third generation (3G) technologies has led to an expansion of wireless services available to consumers. Some of the services now available for wireless subscribers include email, paging, web browsing, and a variety of messaging applications, including SMS messaging and MMS messaging.

The number of user features available in cellular phones is also increasing at a dramatic rate. For example, many cellular phones now include a global positioning system (GPS) receiver for determining the location of the cellular phone, and a Bluetooth module to enable the cellular phone to communicate with nearby devices. Cellular phones are also being combined with other devices, such as cameras, audio players, and personal digital assistants (PDAs).

The plethora of services and features now available in cellular phones creates design challenges for cellular phone manufacturers. One challenge is designing a user interface that allows users to easily access services and features available in their cellular phone. Another challenge is to design a phone which is compact, lightweight, and has a long battery life.

It is neither practical, nor necessarily desirable, to provide buttons for every application available in a cellular telephone. Increasing the number of buttons results in a corresponding increase in the size and weight of the telephone. Additionally, a telephone with too many buttons intimidates many people who are uncomfortable with modern technology. Further, despite the number of services and applications available, many people will still use their phones only for voice services. Cellular phones cluttered with buttons would not appeal to those users who use their phone primarily for voice communications.

One way to provide access to numerous services and applications without cluttering the cellular phone with buttons is to provide a system of menus that can be presented to the user on a display, and a simple method of navigating through the menus and selecting commands, settings, or options. The menu system may be text based, e.g., a listing of features or options, or may be graphical, e.g., a group of icons or a combination of text and graphics. In either case, the user typically navigates through the menu system by selecting items in sequentially-presented menus until the user reaches the desired command, setting, or function. Many applications of interest to the user will reside in a menu several levels below the top level menu. The user must, therefore, remember the sequence of selections that will lead to the desired function. In a cellular phone with a large number of features or functions, the user may have difficulty remembering the precise sequence of selections needed to access the desired function. Even if the user is able to remember the sequence of selections, navigating through the menu system can be tedious and time consuming.

Therefore, there continues to be a need for improvements in user interfaces for wireless communication devices that allows users to easily and quickly access desired features or functions of the wireless communication device.

### SUMMARY OF THE DRAWINGS

The present invention relates to user interfaces for mobile communication devices that allow users to quickly and easily access menus associated with desired functions or features of the mobile communication device. The mobile communication device maintains an event list that lists events requiring some user action. The events may be initiated by a user, such as by setting an alarm, or may be an occurrence outside the control of the user, such as receipt of a message by the mobile communication device. Events may also be initiated by applications residing in the mobile communication device.

The mobile communication device dynamically updates the event list responsive to designated events and displays the event list responsive to user input. In one embodiment of the invention, the user may display the event list by pressing a shortcut key or a combination of keys, or any other access methods. Each event in the event list is associated with a menu item in a hierarchical menu. The associated menu item is invoked when the user selects an event from the event list. The menu item that is invoked may, for example, display another menu or may execute an action associated with the menu item. Thus, the event list provides a simple and consistent method of accessing menus associated with different functions or features of the mobile communication device without having to remember where those menus are located in the hierarchical menu structure.

### BRIEF DESCRIPTION OF THE DRAWINGS

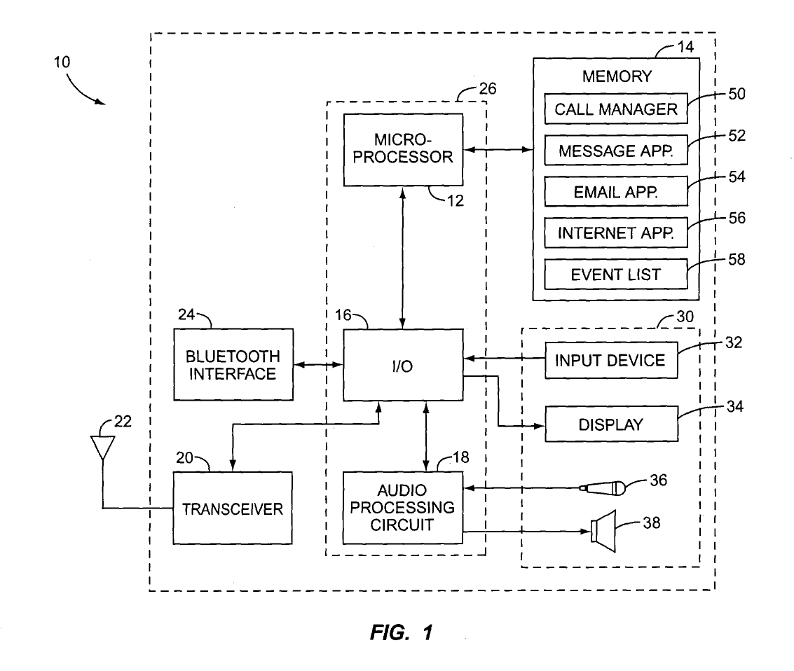

FIG. 1 is a block diagram of an exemplary mobile communication device according to the present invention.

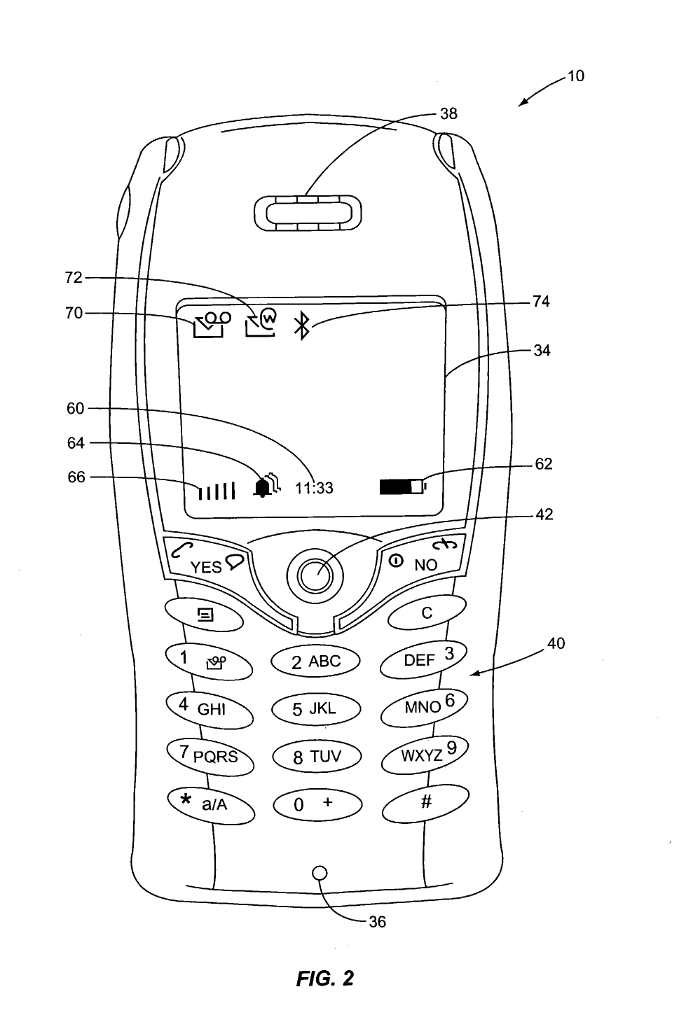

FIG. 2 is an elevational view of an exemplary mobile communication device as seen from the front.

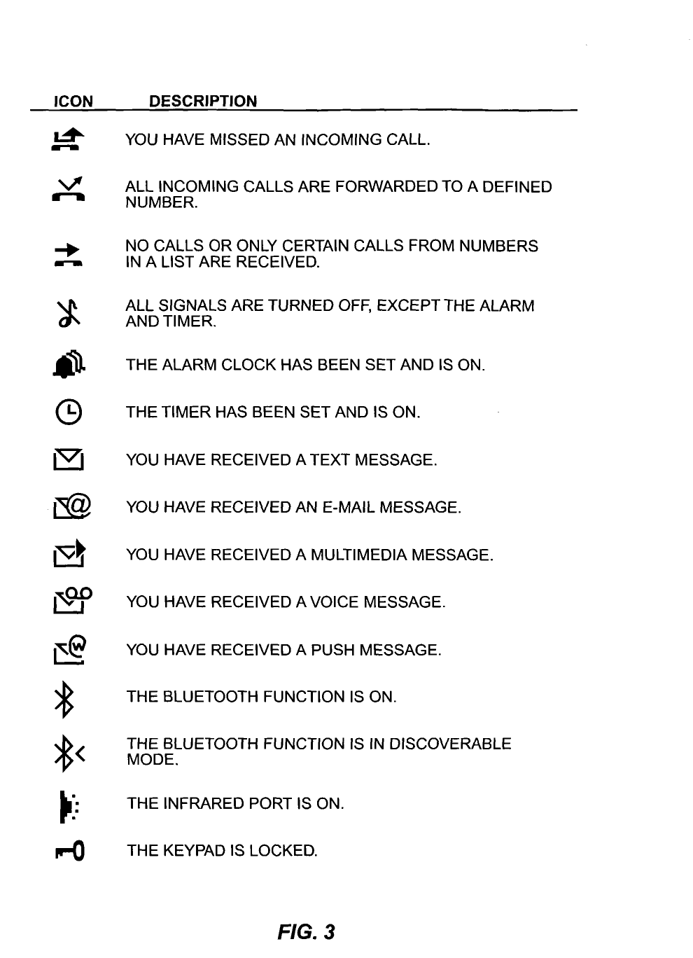

FIG. 3 is a drawing showing event icons that may appear on the display of the mobile communication device.

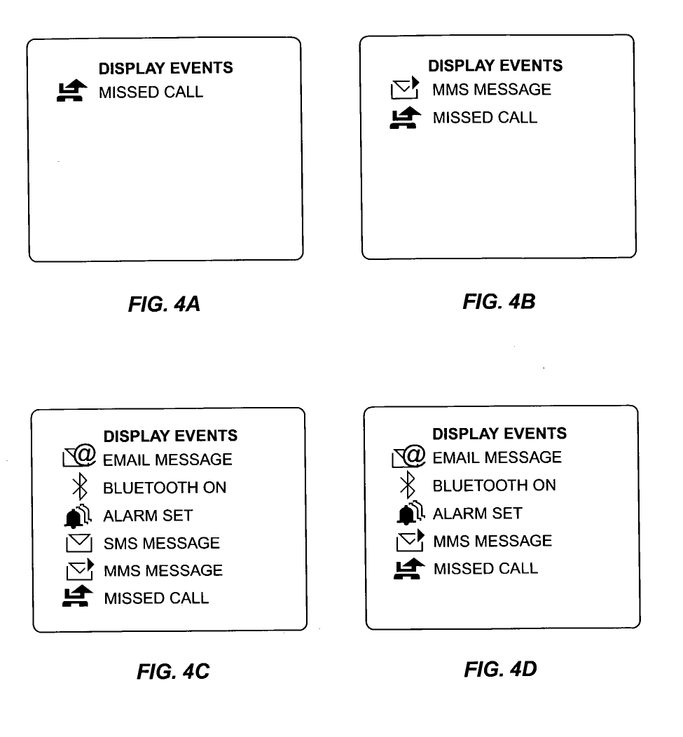

FIGS. 4A-4D illustrate an events menu according to the present invention for accessing menu items in a hierarchical menu.

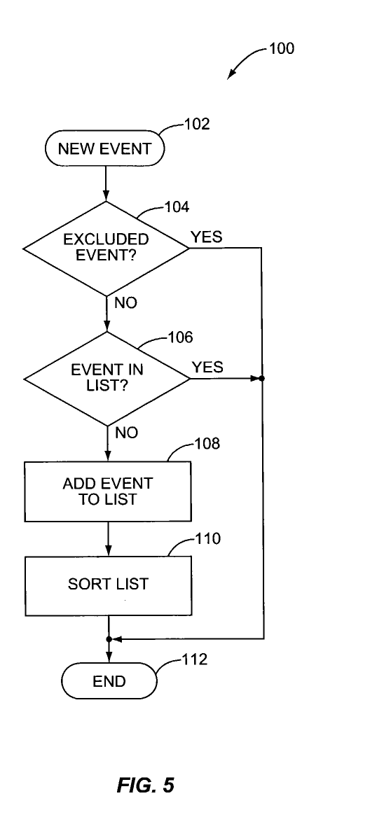

FIG. 5 is a flow diagram illustrating a procedure for adding events to an event list.

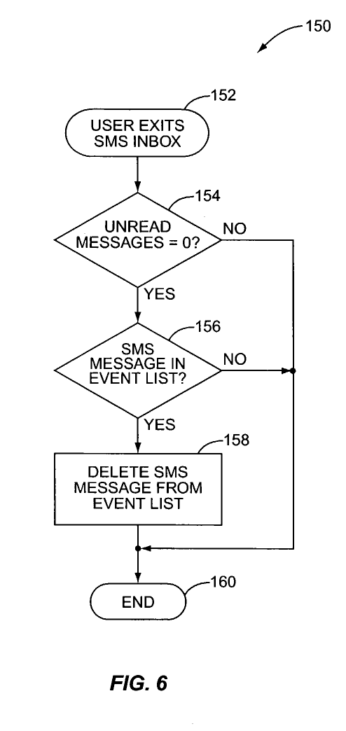

FIG. 6 is a flow diagram illustrating a procedure for deleting events from an event list.

### DETAILED DESCRIPTION OF THE INVENTION

FIG. 1 is a block diagram of an exemplary mobile communication device 10 according to the present invention. The exemplary embodiment comprises a cellular telephone. The present invention is not, however, limited to a cellular telephone and may be embodied in other mobile communication devices, such as a personal digital assistant (PDA).

Mobile communication device 10 comprises microprocessor 12, memory 14, input/output circuit 16, audio processing circuit 18, transceiver 20, antenna 22, and user interface 30. Microprocessor 12 controls the operation of mobile communication device 10 according to programs stored in memory 14. The control functions may be implemented in a single microprocessor 12 or in multiple microprocessors. Suitable microprocessors may include, for example, both general purpose and special purpose microprocessors and digital signal processors. Memory 14 represents the entire hierarchy of memory in a mobile communication device 10, and may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with microprocessor 12. I/O circuits 16 interface the microprocessor 12 with audio processing circuit 18, transceiver 20, and user interface 30. Microprocessor 12, audio processing circuits 18, and input/output circuit 16 may be incorporated into a specially designed application-specific integrated circuit (ASIC) 26.

User interface 30 includes an input device 32, display 34, microphone 36, and speaker 38. Input device 32 and display 34, disposed on the front face of the mobile communication device 10 (FIG. 2), enable the user to interact with the mobile communication device 10. Input device 32 may, for example, comprise an alphanumeric keypad 40 and, optionally, a navigation control, such as joystick control 42 with push-button functionality as shown in FIG. 2. Keypad 40 and joystick control 42 allow the operator to dial numbers, enter commands, navigate menus presented on the display 34, and make selections. Display 34 allows the user to see dialed numbers, status information, prompts, menus, and other information. Display 34 also allows the user to view and read messages and to view images and graphics.

Microphone 36 converts the user's speech into electrical audio signals for transmission by the transceiver 20, and speaker 38 converts audio signals received by the transceiver 20 into audible signals that can be heard by the user. Audio processing circuit 18 provides basic analog output signals to speaker 38 and accepts analog audio inputs from microphone 36.

Transceiver 20 is coupled to antenna 22 for receiving and transmitting signals. Transceiver 20 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA.

The mobile communication device 10 may also include a short-range wireless interface 24 to connect the mobile communication device 10 with nearby devices. For example, the mobile communication device may include a Bluetooth interface and/or an infrared interface. Bluetooth is a wireless technology that makes it possible to connect mobile communication devices 10 with other Bluetooth-enabled devices, such as a PC, printer, or another mobile communication device 10.

The mobile communication device 10 according to the present invention may provide a variety of services in addition to conventional voice communication services. The additional services may include, for example, text messaging using short messaging services (SMS), multimedia messaging using multimedia messaging services (MMS), and internet services such as email and web browsing using the wireless application protocol (WAP). The mobile communication device 10 may also include applications or user features such as a calendar, organizer, and alarm. In a preferred embodiment of the invention, the applications included with the mobile communication device 10 include a call manager 50, a messaging application 52, an email application 54, and internet application 56. Each application may be stored in memory 14, as shown in FIG. 1. The call manager 50 maintains a list of contacts with addresses and phone numbers and handles incoming and outgoing voice calls. One function performed by the call manager 50 is to maintain call lists, which may include a list of recent calls and a list of missed calls. The messaging application 52 provides SMS and MMS messaging services. Incoming SMS and MMS messages are stored in an inbox until read or viewed by the user. After reading or viewing, the messages are deleted from the inbox. The email application 54 allows the user to send and receive emails. The email application 54 may also include an inbox to store unread messages. The internet application 56 includes a web browser that allows the user to browse web pages. The internet application 56 also allows the user to send and receive WAP messages.

During use, the various applications being run by the microprocessor 12 may cause icons to be displayed on the display 34 to provide notices or alerts to the user, as well as to provide status information. FIG. 2 illustrates a few exemplary icons as they would appear to a user during use of the mobile communication device 10. In the example illustrated in FIG. 2, the mobile communication device 10 is displaying the time, denoted by reference numeral 60, at the bottom of the display 34. A battery icon 62 is displayed to the right of the time 60 to indicate the remaining battery life. To the left of the time 60 is an alarm icon 64 and signal strength icon 66. The alarm icon 64 indicates that an alarm 64 has been set and is active. The signal strength icon 66 indicates the current signal strength as seen by the mobile communication device 10. At the top of the display 34 are three icons, which are respectively a voice mail icon 70, a WAP message icon 72, and a Bluetooth icon 74, associated with events that require some user action. The voice mail icon 70 indicates the user has received a voice message that has not been previously accessed by the user. The WAP message icon 72 likewise indicates that the user has received an unaccessed WAP push message. The Bluetooth icon 74 indicates that the Bluetooth interface is enabled and active. Some additional icons that may appear on the display are shown in FIG. 3. The icons shown in FIG. 3 are associated with events that require user action

Although the display 34 provides a convenient method to notify the user of events or to display status information, it may still not be readily apparent to many users what action needs to be taken to respond to a notification or to change a current status. Conventionally, access to services or features of the mobile communication device 10 is obtained via hierarchical menus displayed to the user on display 34. Table 1 below is a partial listing of menu items that may appear in a typical hierarchical menu for a mobile terminal.

TABLE 1
Menu

| Top Level | 2nd Level | 3rd Level |
|---|---|---|
| Messages | | |
| | SMS | |
| | | Write new |
| | | Inbox |
| | | Unsent |
| | | Sent items |
| | | Options |
| | MMS | |
| | | Write new |
| | | Inbox |
| | | Unsent |
| | | Sent items |
| | | Options |
| | E-mail | |
| | | Send & Receive |
| | | Inbox |
| | | Write new |
| | | Outbox |
| | Push inbox | |
| | | Inbox |
| | | Clear push inbox |
| | | Push access |
| Calls | | |
| | Missed Calls | |
| | Call List | |
| | Manage Calls | |
| | | Forward Calls |
| | | Accept Calls |
| | | Call Waiting |
| Web Services | | |
| | in Mode Line | |
| | Bookmarks | |
| | | Add bookmark |
| | | BM1 |
| | | BM2 |
| | | BM3 |
| | Push inbox | |
| Organizer | | |
| | Calendar | |
| | Notes | |
| | Alarms | |
| | | Alarm |
| | | Recurrent Alarm |
| | Timer | |
| Connect | | |
| | Infrared port | |
| | Bluetooth | |

The user may use the joystick 42 or keypad 40 to navigate through a series of menus to access messages or other services, change or view settings, and enable or disable functions. Hierarchical menus are well known in the art and commonly used because menus do not take up space and can be easily implemented in small devices. The number of functions that can be accessed via menus is limited only by available memory. While display menus can accommodate a large number of features or functions in a mobile communication device 10, the complexity of display menus gets more complex with each added feature or function.

Many users have difficulty navigating through complex menu structures to access services, functions or features, particularly when the function is one that is seldom used. In the above example, if the user decided to disable the Bluetooth interface, the user would have to navigate through the menus to find the command to disable the Bluetooth menu item, which may reside in a menu several levels below the top-level menu. Even if the user is able to remember the sequence of steps to get to the Bluetooth menu item, navigation through the menus may still be tedious.

The present invention provides a method of accessing services and features of a mobile communication device 10. According to the present invention, the microprocessor 12 maintains a list of all active events that is dynamically updated as new events occur and stores the updated event list 58 in memory 14. An event may be initiated by the user, such as when the user enables the Bluetooth interface or sets an alarm. Events may also be initiated by the network, such as when the user receives a call, or by an application in the mobile communication device 12. When an event occurs, the microprocessor 12 updates the event list 58, which serves as a customized menu for quickly accessing services or features of the mobile communication device 10. The event list 58 comprises a collection of pointers to the locations of menu items corresponding to the events in the event list 58. For example, if the user misses a call, the microprocessor 12 may place a pointer to a Missed Calls menu item in the event list 58. As another example, if the user enables the Bluetooth interface, the microprocessor 12 may place a pointer in the event list 58 that points to a menu item for disabling the Bluetooth interface.

The user interface 30 preferably includes a shortcut key that allows the user to quickly access and display the event list 58 from a standby mode. The shortcut key may comprise a press of a single key or a combination of keys. The shortcut key or key sequence is referred to hereinafter as the Event List shortcut. Once the event list 58 is displayed, the user can simply select a desired action from the event list 58 regardless of the type of event. Selecting an event from the event list invokes a menu item in the hierarchical menu. The menu item invoked may cause a menu to be displayed on the screen, or may execute some action or function associated with that menu item. Thus, the event list 58 provides a simple and consistent method of accessing widely disparate features of the mobile communication device 10. The following examples are provided to illustrate some of the uses of the present invention.

### EXAMPLE 1

The user has missed a voice call. A missed call icon (the first icon in FIG. 3) is displayed on the display 34 to notify the user of the missed call. The user activates the Event List shortcut to display the event list 58 on the display 34. The event list 58, shown in FIG. 4A, includes a pointer to a Missed Calls menu item. When the user selects “Missed Call” from the event list 58, the user is taken directly to a list of missed calls. The Missed Calls pointer will remain in the event list 58 until the user has responded to or deleted all of the missed calls in the Missed Calls list. When the user responds to the last missed call, the microprocessor 12 removes the Missed Call pointer from the event list 58.

### EXAMPLE 2.

The user has a missed voice call and a missed MMS message pending. A Missed Call icon and MMS Message icon are displayed on the display 34. When the user activates the Event List shortcut, the event list 58 shown in FIG. 4B is displayed. The event list 58 now contains two pointers, one to an MMS message inbox and one to a Missed Call list. The user can select either “MMS Messages” menu item or “Missed Calls” menu item from the event list 58. If the user selects the “Missed Calls” menu item from the event list 58, the user is taken directly to a Missed Calls list as previously described. If the user selects the “MMS Messages” menu item, the user is taken to a MMS message inbox where the user can view all unread MMS messages. The MMS Message pointer will remain in the event list 58 until the user has viewed or deleted all of the unread MMS messages. When the last unread MMS message is viewed, the microprocessor 12 removes the MMS Message pointer from the event list 58.

### EXAMPLE 3

In addition to the missed call and unread MMS referred to in Example 2, the user has an unread SMS message, has set an alarm, has enabled the Bluetooth interface, and has an unread email message. Corresponding icons are displayed on the display 34. When the user activates the Event List shortcut, the event list 58 shown in FIG. 4C is displayed. The event list 58 now contains six pointers corresponding to six different events. Each pointer serves as a shortcut to a menu item in the hierarchical menu structure allowing the user to directly access services or features without having to remember where the corresponding menu items are located. If the user wants to check his or her SMS messages, the user can select the “SMS Messages” item from the event list 58, which is really a pointer to the user's SMS inbox. Selection of the “SMS Message” item will therefore take the user directly to the SMS inbox. After the user has read all previously unread SMS messages, the microprocessor 12 removes the “SMS Message” item from the event list 58. The event list 58 will then include five items as shown in FIG. 4D.

In the above examples, the items in the event list 58 are ordered based on the time of the events with the most recent event first. A different order could be used. For example, the user could assign priority levels to different events, which would be displayed in order of priority. In some embodiments, the user may be able to specify events to include or exclude from the event list 58. Ordering could also be based on frequency of use. The microprocessor 12 could maintain statistics reflecting the frequency of use of different features and order items in the event list 58 based on the usage statistics.

FIG. 5 illustrates an update procedure 100 that may be executed by the microprocessor 12 for updating the event list 58 responsive to new events. The update procedure 100 begins when an event is detected (block 102). The events that trigger the procedure may be determined by programs installed by the manufacturer or, in some embodiments, may be specified by the user. In this case, it is assumed that the events are preprogrammed by the manufacturer and that the user has the ability to exclude preprogrammed events from the event list 58. In this scenario, microprocessor 12 initially checks whether the event is one that has been excluded by the user from the event list 58 (block 104). If so, the procedure ends (block 112) without updating the event list 58. If the event has not been excluded, the microprocessor 12 checks whether the event is already included in the event list 58 (block 106). In a preferred embodiment of the invention, a single item in the event list 58 appears whether there is a single occurrence of the event or multiple occurrences of the same type of event. For example, if the user receives an SMS message when unread SMS messages already exist in the SMS inbox, the “SMS Message” icon will already appear in the event list 58. In this case, the event list 58 is not updated and the procedure ends (block 112) without updating the event list 58. If the event is a type that has not previously occurred and is not already represented in the event list 58, the microprocessor 12 adds the new event to the event list 58 (block 108) and sorts the list (block 110) according to any desired sorting algorithm. After updating the event list 58 (blocks 108 and 110), the procedure ends (block 112).

FIG. 6 illustrates an exemplary procedure 150 for deleting events from the event list 58. The procedure shown in FIG. 6 may be included within or called by another procedure. The exemplary procedure 150 shown in FIG. 6 is executed when a user exits from an SMS inbox (block 152) maintained in the mobile communication device 10 and may therefore be included as part of other SMS program codes. When the user exits from the SMS inbox, the microprocessor 12 determines the number of unread SMS messages (block 154). If the number of unread messages in the SMS inbox is greater than 0, the microprocessor 12 does not take any action and the procedure ends (block 160). If, however, the number of unread SMS messages in the SMS inbox is equal to 0, the microprocessor 12 checks whether the “SMS Message” event is in the event list 58. If not, microprocessor 12 does not take any action and the procedure ends (block 160). However, if the “SMS Message” event is in the event list 58 and the number of unread messages is equal to 0, the microprocessor removes or deletes the “SMS Message” event from the event list 58 (block 158) and the procedure ends (block 160).

FIG. 6 illustrates one exemplary procedure that may be included in SMS applications. Procedures similar to that shown in FIG. 6 may also be provided for handling other forms of messages, such as voice calls, email messages, MMS messages.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

1. A method of accessing functions in a mobile communication device comprising:
dynamically updating an event list responsive to designated events;
displaying said event list to a user on a display;
associating a menu item in a hierarchical menu with each event in said event list; and
invoking the associated menu item in said hierarchical menu responsive to selection of an event from said event list by said user.

2. The method of claim 1 wherein dynamically updating an event list responsive to designated events comprises adding events to said event list when a new event occurs.

3. The method of claim 1 wherein dynamically updating an event list responsive to designated events comprises deleting events from said event list responsive to user actions.

4. The method of claim 1 wherein said event list is displayed responsive to entry of a shortcut command by said user.

5. The method of claim 1 further comprising sorting said event list before said event list is displayed.

6. The method of claim 5 wherein said event list is sorted in time order.

7. The method of claim 5 wherein said event list is sorted based on priorities assigned to said events on said event list.

8. The method of claim 7 wherein said priorities are assigned to said events on said event list by a user.

9. The method of claim 5 wherein said event list is sorted based on usage statistics associated with said events on said event list.

10. A mobile communication device comprising:
a display for displaying menu items in a hierarchical menu for selection by a user;
a memory for storing an event list;
a processor to:
dynamically update said event list responsive to designated events;
display said event list on a display for viewing by a user;
associate a menu item in a hierarchical menu with each event in said event list; and
invoke the associated menu item in said hierarchical menu responsive to selection by said user of an event from said event list.

11. The mobile communication device of claim 10 wherein the processor adds events to said event list when a new designated event occurs.

12. The mobile communication device of claim 10 wherein the processor deletes events from said event list responsive to user actions.

13. The mobile communication device of claim 10 wherein the processor displays said event list responsive to entry of a shortcut command by said user.

14. The mobile communication device of claim 10 wherein said processor sorts said event list before said event list is displayed.

15. The mobile communication device of claim 14 wherein said processor sorts said event list in time order.

16. The mobile communication device of claim 14 wherein said processor sorts said event list based on priorities assigned to said events on said event list.

17. The mobile communication device of claim 16 wherein said priorities are assigned to said events on said event list by a user.

18. The mobile communication device of claim 10 wherein said processor sorts said event list based on usage statistics associated with said events on said event list.

19. A circuit for controlling a user interface including a display, said circuit comprising a processor programmed to:
generate and dynamically update an event list responsive to designated events;
display said event list on said display for viewing by a user;
associate a menu item in a hierarchical menu with each event in said event list; and
invoke the associated menu item in said hierarchical menu responsive to selection by said user of an event from said event list.

20. The circuit of claim 19 wherein the processor adds events to said event list when a new designated event occurs.

21. The circuit of claim 19 wherein the processor deletes events from said event list responsive to user actions.

22. The circuit of claim 19 wherein the processor displays said event list responsive to entry of a shortcut command by said user.

23. The circuit of claim 19 wherein said processor sorts said event list before said event list is displayed.

24. The circuit of claim 23 wherein said processor sorts said event list in time order.

25. The circuit of claim 23 wherein said processor sorts said event list based on priorities assigned to said events on said event list.

26. The circuit of claim 25 wherein said priorities are assigned to said events on said event list by a user.

27. The circuit of claim 19 wherein said processor sorts said event list based on usage statistics associated with said events on said event list.

28. A computer program stored in a computer readable medium for controlling a user interface in a mobile communication device, said program including instructions to cause said mobile communication device to:
generate and dynamically update an event list responsive to designated events;
display said event list on a display for viewing by a user;
associate a menu item in a hierarchical menu with each event in said event list; and
invoke the associated menu item in said hierarchical menu responsive to selection by said user of an event from said event list.
